(19) United States
(12) Patent Application Publication
(10) Pub. No.: US 2023/0095841 A1
(43) Pub. Date: Mar. 30, 2023

(54) Sonar Reflective Fishing Lures and Terminal Tackle

(71) Applicants: J. Barton Langley, Russellville, AR (US); Jeremy Starks, Red House, WV (US)

(72) Inventors: J. Barton Langley, Russellville, AR (US); Jeremy Starks, Red House, WV (US)

(21) Appl. No.: 17/957,407

(22) Filed: Sep. 30, 2022

Related U.S. Application Data
(60) Provisional application No. 63/251,005, filed on Sep. 30, 2021.

(51) Int. Cl. A01K 85/01

(52) U.S. Cl. CPC A01K 85/018

(57) ABSTRACT

A sonar reflective fishing lure or terminal tackle that includes a body, sonar reflective surfaces that are raised from the exterior body or recessed in the exterior body, and a hook connected to the exterior body. The sonar reflective surfaces face in different directions, which causes the fishing lure or terminal tackle to have enhanced sonar reflectivity and allows at least some of the reflective surfaces to be contacted by a sonar beam of a fish finder regardless of the positioning of the fishing lure or terminal tackle relative to the sonar beam.

### CROSS-REFERENCE TO RELATED APPLICATIONS

This application claims the benefit of U.S. Provisional Application No. 63/251,005, entitled “Sonar Reflective Composition for Fishing Lures” and filed on Sep. 30, 2021. The complete disclosure of said patent application is hereby incorporated by reference.

### STATEMENT REGARDING FEDERALLY SPONSORED RESEARCH OR DEVELOPMENT

Not applicable

### BACKGROUND OF THE INVENTION

Sonar fish finders are commonly utilized by freshwater fisherman to identify underwater topography for promising fishing areas as well as to locate schools of fish. The fish finders operate through sending and receiving sonar signals. The transducer of the fish finder sends sonar signals into the water, which then bounce off objects in the water. The returned signals are then received by the transducer of the fish finder and interpreted. The structures and fish under the boat and even the location of the fisherman's fishing lure are displayed on the screen of the fish finder. However, the location of the fishing lure is often difficult to see on the screen because many lures absorb the sonar beam instead of reflecting it.

It would therefore be desirable to develop fishing lures and terminal tackle that provide a more reflective surface for the sonar beam of the fish finder in order to increase the visibility of the fishing lure and/or terminal tackle on the display of fish finder.

### BRIEF SUMMARY OF THE INVENTION

The present invention is directed to a sonar reflective fishing lure or terminal tackle that includes a body, sonar reflective surfaces that are raised from the body or recessed in the body, and a hook connected to the body. The sonar reflective surfaces face in different directions and define an outline of a shape that may be repeating. The sonar reflective surfaces facing in different directions causes the fishing lure or terminal tackle to have enhanced sonar reflectivity because the sonar waves are effectively reflected by the surfaces. The positioning of the reflective surface also allows at least some of the surfaces to be contacted by a sonar beam of a fish finder regardless of the positioning of the fishing lure or terminal tackle relative to the sonar beam.

These and other features, objects and advantages of the present invention will become better understood from a consideration of the following drawings, detailed description of the preferred embodiments and appended claims.

### BRIEF DESCRIPTION OF THE DRAWINGS

FIG. 1 is a perspective view of a fishing lure of the present invention comprising a raised pattern of hexagons on the body of the fishing lure.

FIG. 2 is a perspective view of a jig head of the present invention comprising a raised pattern of triangles on the body of the jig head.

### DETAILED DESCRIPTION OF THE INVENTION

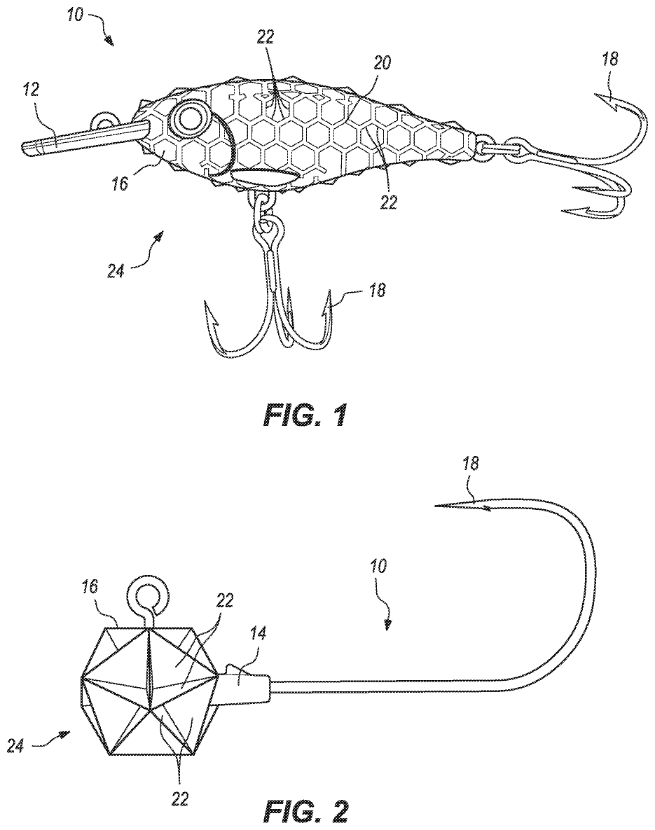

With reference to FIGS. 1-2, the preferred embodiments of the present invention may be described.

In one embodiment, the present invention is directed to artificial fishing lures or terminal tackle 10 having sonar reflective surfaces. The outer surface 16 of the body 24 of the fishing lure 12, such as a crankbait as shown in FIG. 1, or terminal tackle 14, such as the jig head shown in FIG. 2, include a plurality of sonar reflective surfaces 22. The sonar reflective surfaces 22 together define an outline 20 of a shape. The shapes, such as hexagons or triangles shown in FIGS. 1-2, may repeat across some or all of the outer surface of the fishing lure or terminal tackle. The reflective surfaces 22 may either be raised from the body or recessed from the body. For example, the reflective surfaces may be raised 1-2 mm from the body of the fishing lure. As such, there is a depth between the top edge of the reflective surfaces 22 and the space formed between the reflective surfaces, which aids in the reflectivity of the fishing lure or terminal tackle because the sonar waves are effectively reflected. In one embodiment, the extent to which the reflective surfaces are raised or recessed differs at one position of the fishing lure or terminal tackle compared to another position.

The sonar reflective surfaces 22 face in different directions, which allows at least some of the reflective surfaces 22 to be contacted by the sonar beam of the fish finder regardless of the positioning of the fishing lure or terminal tackle relative to the sonar beam. This also makes the fishing lure more reflective and therefore more visible on the display screen. To create these reflective surfaces 22 facing in different directions, the repeating shapes include interior angles. For example, in FIG. 1, the outline in the shape of a hexagon includes multiple 120-degree angles. As another example, in FIG. 2, the outline in the shape of a triangle includes multiple 60-degree angles. However, it should be understood that shapes other than a hexagon or triangle may be used on the body of the fishing lure or terminal tackle.

As shown in FIGS. 1, a hook 18 is attached to the body 24 of the fishing lure 12. When the terminal tackle 14 is a jig head, a hook 18 is attached to the body 24 of the jig head, as shown in FIG. 2.

The present invention is also directed to a sonar reflective composition for fishing lures and terminal tackle. In one embodiment, the composition is preferably a gel that includes a suspended mixture of one or more powdered metals. The gel is preferably a silicone-based or petroleum-based gel. The powdered metals may include copper, aluminum, tungsten, iron, bronze, stainless steel, and carbon steel, but other high density and high reflectivity metals may alternatively be used. The gel is preferably contained in a small bottle similar to the size of a fingernail polish bottle that is easily storable in the fisherman's tackle box. To apply the composition to a fishing lure or terminal tackle, the fisherman opens the bottle and brushes the composition onto the exterior surface of the fishing lure or terminal tackle that the fisherman intends to use. In one embodiment, the gel also preferably includes a masking scent or fish attractant. The masking scent or fish attractant may include garlic, anise, crawfish, shad, squid, shrimp, and coffee scents. Because the gel has a limited life once applied to the fishing lure, the gel must be re-applied regularly for maximum effectiveness. The powdered metal suspended in the gel makes the fishing lure or terminal tackle much more reflective to the sonar beam of the fish finder. As a result, the fishing lure or terminal tackle appears much brighter on the display screen of the fish finder and is easier to see on the screen by the fisherman. In addition to their reflectivity characteristics, powdered metals were chosen because they do not add a substantial amount of weight to the fishing lure.

In yet another embodiment, instead of the composition being applied to the exterior surface of the fishing lure or terminal tackle right before the lure or tackle is to be used, the mixture of powdered metals is included throughout the plastic lure or terminal tackle. By mixing the powdered metals with the plastic liquid that the fishing lure or terminal tackle is manufactured from in an injection mold process, the powdered metals are consistently present throughout the fishing lure or terminal tackle. The powdered metals in the fishing lure or terminal tackle makes the fishing lure or terminal tackle much more reflective to the sonar beam of the fish finder. As a result, the fishing lure or terminal tackle appears much brighter on the display screen of the fish finder and is easier to see on the screen by the fisherman.

It should be understood that the reflective composition and the pattern of shapes created by the sonar reflective surfaces described in this application may be used with any type of artificial fishing bait or terminal tackle, including, but not limited to, jig heads, fishing weights, and beads.

The present invention has been described with reference to certain preferred and alternative embodiments that are intended to be exemplary only and not limiting to the full scope of the present invention.

We claim:

1. A fishing lure or terminal tackle, comprising:
a body;
a plurality of sonar reflective surfaces extending from said exterior body and facing in different directions, wherein said sonar reflective surfaces define an outline of a shape; and
a hook connected to said body.

2. The fishing lure or terminal tackle of claim 1, wherein said sonar reflective surfaces are raised from said body or recessed in said body.

3. The fishing lure or terminal tackle of claim 1, wherein said sonar reflective surfaces form an outline of a shape that is repeating.

4. The fishing lure or terminal tackle of claim 1, wherein said fishing lure or terminal tackle is an artificial fishing lure.

5. The fishing lure or terminal tackle of claim 1, wherein said fishing lure or terminal tackle is a jig head.

6. The fishing lure or terminal tackle of claim 1, wherein said body is comprised of a plastic and a powdered metal.

7. The fishing lure or terminal tackle of claim 6, wherein said powdered metal is copper, aluminum, tungsten, iron, bronze, stainless steel, or carbon steel.

8. The fishing lure or terminal tackle of claim 1, wherein a composition covers said exterior body, wherein said composition comprises a gel and a powdered metal.

9. The fishing lure or terminal tackle of claim 8, wherein said powdered metal is copper, aluminum, tungsten, iron, bronze, stainless steel, or carbon steel.

10. The fishing lure or terminal tackle of claim 8, wherein said composition comprises a masking scent.

11. A sonar reflective fishing lure or terminal tackle, comprising:
a body;
a plurality of sonar reflective surfaces that are raised from said body or recessed in said body, wherein said plurality of sonar reflective surfaces face in different directions and define an outline of a shape, wherein said outline of said shape is repeating; and
a hook connected to said body.

12. The fishing lure or terminal tackle of claim 11, wherein said fishing lure or terminal tackle is an artificial fishing lure.

13. The fishing lure or terminal tackle of claim 11, wherein said fishing lure or terminal tackle is a jig head.

14. The fishing lure or terminal tackle of claim 11, wherein said body is comprised of a plastic and a powdered metal.

15. The fishing lure or terminal tackle of claim 14, wherein said powdered metal is copper, aluminum, tungsten, iron, bronze, stainless steel, or carbon steel.

16. The fishing lure or terminal tackle of claim 11, wherein a composition covers said exterior body, wherein said composition comprises a gel and a powdered metal.

17. The fishing lure or terminal tackle of claim 16, wherein said powdered metal is copper, aluminum, tungsten, iron, bronze, stainless steel, or carbon steel.

18. The fishing lure or terminal tackle of claim 16, wherein said composition comprises a masking scent.
